(19) United States
(12) Patent Application Publication
(10) Pub. No.: US 2019/0241249 A1
(43) Pub. Date: Aug. 8, 2019

(54) WINGS FOR FLYING OBJECTS (VARIANTS)

(71) Applicant: Gevorg Serezhaevich NOROYAN, Primorski krai (RU)

(72) Inventor: Gevorg Serezhaevich NOROYAN, Primorski krai (RU)

(21) Appl. No.: 16/342,541

(22) PCT Filed: Oct. 12, 2017
(86) PCT No.: PCT/RU2017/000754

§ 371 Date: Apr. 17, 2019

(30) Foreign Application Priority Data
Oct. 17, 2016 (RU) 2016140569

(51) Int. Cl. B64C 3/14; B64C 1/00

(52) U.S. Cl. CPC B64C 3/14; B64C 2001/0045; B64C 1/00

(57) ABSTRACT

The group of inventions relates to the field of aircraft. In each variant, a flying object (FO) comprises a body and wings. In a first variant, an FO comprises wings mounted so as to be capable of rotating the FO. In a second variant, an FO comprises a body on which is mounted a rim with side wings. In a third variant, an FO comprises wings in the shape of a triangular prism, one side of which is fastened to the body, and the other two sides of which are spherical with arcs of different radii. In a fourth variant, the FO comprises tail wings fastened to the body such that the exhaust gases from the nozzle impinge on the wings and create a force which rotates the FO.

[symbol]

For an aircraft and an FO, where the body does not rotate, the side wings are fastened mechanically to a rim, with which the flying object is equipped. The rim is mounted on the body of the FO, on hinges, so that it easily rotates on the body, by various known methods.

For rockets and for those flying objects that rotate about their own axis, side wings are fastened mechanically on the body, starting from the front part of the body, at least two of them, along the entire length of the FO (rocket). The body of the FO may also be constructed with a coil. On the body there are at least two coils, which extend with identical pitch from the nose section to the tail section.

For those FOs (rockets, spaceships) that are provided with fuel for increasing the speed, tail wings are fastened on the body in the rear section.

The tail wings may be made from flat heat-resistant metal of any known type, individually fixed mechanically, uniformly on the tail section of the rocket. These wings all extend in one direction so that the exhaust gases impinge on them tangentially, to increase the rotating force. The number and size of the tail wings vary, depending on the concrete case.

The tail wings may be in the form of a flat bar extending from the mid-point in different directions, which passes along the axis of the FO and is fastened on the body at the sides. The tail wings extend so that on discharge of the exhaust gases they transmit a rotating force in the same direction as the side wings. The tail wings for those FOs that do not rotate about their axis transmit the rotating force to the rim with the side wings, by any known method.

The invention is explained by the following figures:

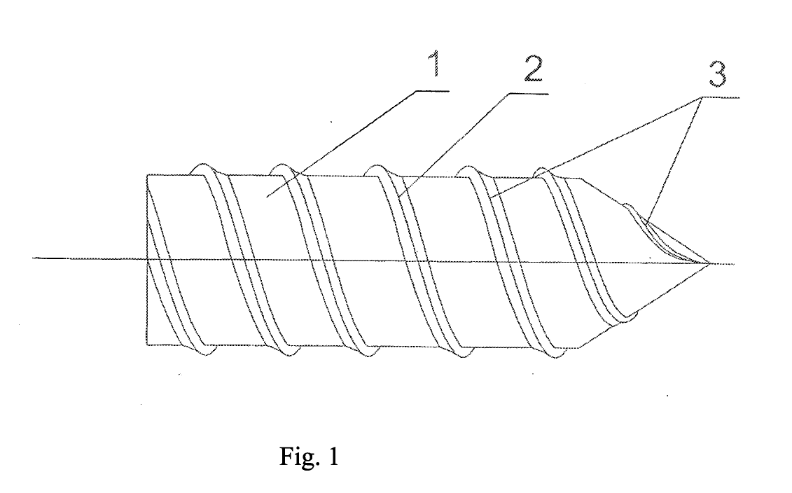

FIG. 1: 1—body of the rocket; 2—first coil; 3—second coil.

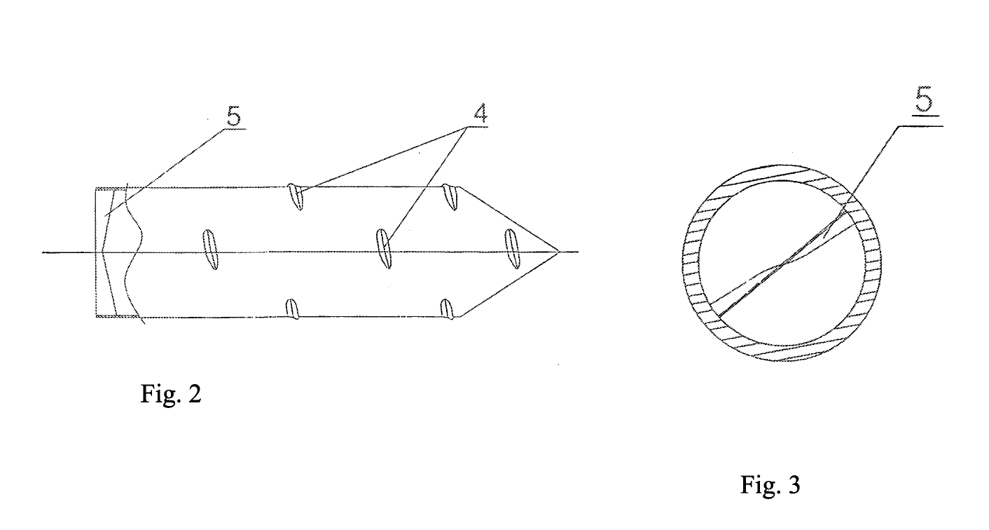

FIG. 2: 4—side wings; 5—tail wing with one bar.

FIG. 3: 5—tail wing with one bar, rear view.

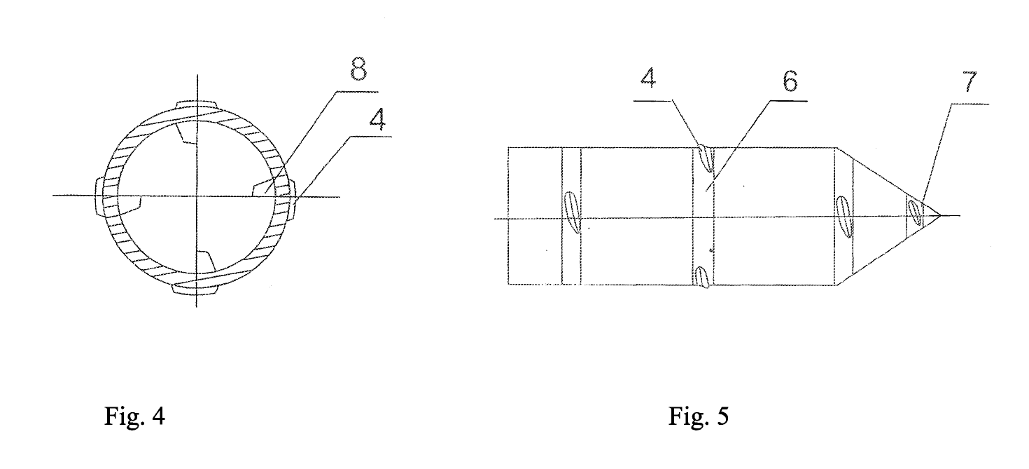

FIG. 4: rear view of the FO; 4—side wings; 8—tail wings (possible type) from the rear of the FO.

FIG. 5: 4—side wings; 7—rim on the nose section; 6—rim on the body of the FO;

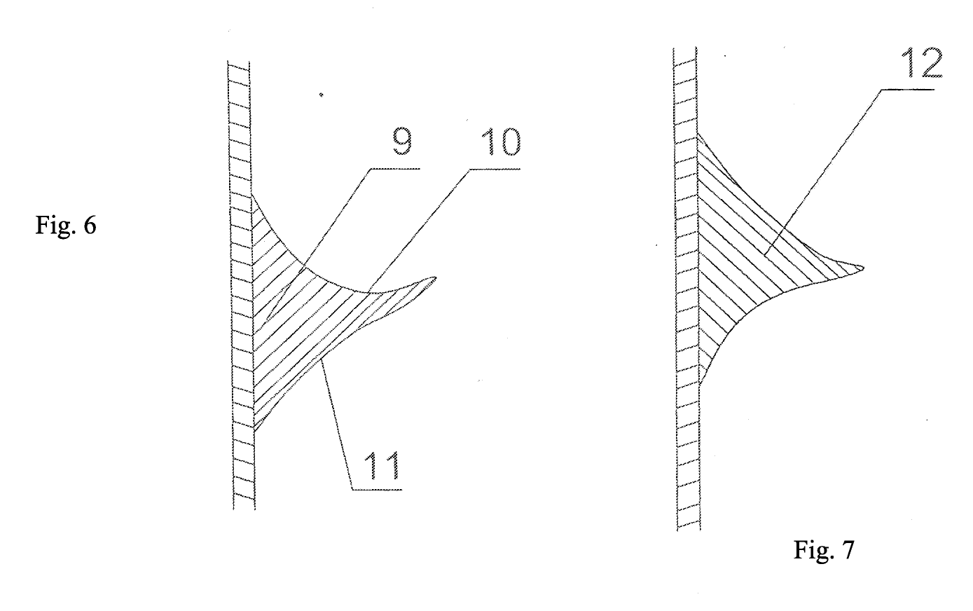

FIG. 6: 9—side wing in section; 10—leading side of the side wing; 11—trailing side of the side wing.

FIG. 7 shows a possible variant of the side wings—12

On the body of the flying objects (FO) 1, which are in the form of a cylinder, side wings 4 are mounted mechanically in various places along the length, beginning with the nose cone, they are perpendicular to the axis of the FO, if the FO is viewed from the front, and at an angle to the axis, if the FO is viewed from the side, so that during motion the headwind impinges on the side wings 4 at the front section 10 and they cause the FO to spin, and during rotation the trailing side 11 of the side wings pushes the air away from the FO, the side wings 4 are of various known from and at least two are mounted along the entire length of the FO, and are uniformly distributed circumferentially on the body of the FO 1.

For those FOs that do not rotate about their axis, rims 6 and 7 are mounted on bearings (not shown) in various places along the entire length, beginning with the nose cone, in such a way that the rim rotates easily on the body of the FO; side wings are mounted mechanically on the rim, the FO is provided with a propulsive device (not shown), which by various known methods transmits rotation to the rim, and each rim may be provided with at least one propulsive device, which causes the rim 6 and 7 to spin, for more effectively overcoming the air resistance.

The rim 6 and 7 may also be constructed with at least two coils (not shown), the coils begin at the front section of the rim starting from zero and they gradually get larger to form a trihedral arc-shaped prism, with identical pitch of the coil, from the direction of the headwind and from the trailing side of the surface of the coil, spherical with an arc inside (in an arc to one another), the pitch of the coils is different.

The wings 4 may be in the form of a trihedral prism, and are fastened mechanically on the body of the FO or on the rim, and on one side repeats the radius of the FO, and lie closely thereon, whereas the other two side wings 10 and 11 are spherical, with an inward arc with varying radius, at both ends the wings 4 are rounded and are tapering in the direction of rotation (not shown), so as to cut through the air mass easily, the height of the wing from the FO and the width of the wing, which lie on the body of the FO and the length of the wing, is different, and is calculated for each case separately.

The tail wings 8 are fastened mechanically on the tail section of the body of the FO, they are of flat metal of various known type, the tail wings are fastened on the body of the FO in such a way that on one side they project at the back towards the discharge of exhaust gases, and at an angle to the axis of the FO, so that the exhaust gases on being discharged from the nozzle impinge on the wings 8 tangentially and rotate the wings.

The tail wings 5 may be made of heat-resistant metal in the form of flat bar stretched at the middle and in the middle they are curved in different directions with varying angle of inclination. The tail wings may transmit the rotating force to the rim 6 by any known method.

The operation of the FO is as follows: for an FO that does not rotate about its axis during motion from standstill, under the pressure of the oncoming air on the side wings (or coils) they cause the rim to spin. On the trailing side of the wing the air mass is pushed away from the body of the FO, in the absence of resistance from the air, the FO easily picks up speed, the propulsive device with which the FO is equipped helps in rotation of the rim, the wings not only remove the negative effects of the oncoming air, but also being supported on the air, propel the FO forwards. The tail of the wing also helps the rim to rotate, and the wings push the air more intensively away from the body of the FO, and the FO forwards. For an FO that rotates about its axis during starting under the pressure of the oncoming air on the side wings and by means of the tail wings, on which the exhaust gases from the nozzle exert pressure, they cause the FO to spin about its axis. The side wings during rotation on the trailing side push the air mass from the FO sideways. The higher the rotary speed, the more effectively the wings push the air away sideways and, being supported on the air, push the FO away forwards. With minimal resistance from the oncoming air, the FO is capable of covering a great distance, and of saving fuel.

1. Aerodynamic wing profile, characterized in that, on the body of flying objects (FOs), which are in the form of a cylinder, side wings are mounted mechanically in various places along the length, starting from the nose cone, they are perpendicular to the axis of the FO, if the FO is viewed from the front, and at an angle to the axis, if the FO is viewed from the side, the angle may be inclined from 0° to 45°, so that during motion the headwind impinges on the side wings at the front and cause the FO to spin, and during rotation the side wings on the trailing side push the air away from the FO, the side wings are of various known types, and at least two are mounted on each length of the FO, and are uniformly distributed on the circumference of the body of the FO.

2. Aerodynamic wing profile, characterized in that, on the body of flying objects (FOs), which are in the form of a cylinder, a rim with side wings is mounted on bearings in various places along the length, starting from the nose cone, and so that the rim rotates easily on the body of the flying object, a coil or side wings are mounted mechanically on the rim.

3. Wing according to claim 2, characterized in that the FO is provided with a propulsive device, which by various known methods transmits rotation to the rim, and causes the rim with the wings to spin, for more intensively overcoming the air resistance.

4. Wing according to claim 2, characterized in that the rim is constructed with at least two coils, the coils begin at the front of the rim, from zero and gradually get larger to form a trihedral arc-shaped prism, with identical pitch of the coil, from the direction of the headwind and from the trailing side of the face of the coil spherical with an inward arc (in an arc to one another), and the pitch of the coils varies.

5. Aerodynamic wing profile, characterized in that, for FOs (pilotless and rockets) the wings are in the form of a trihedral prism, and are fastened mechanically on the body of the FO, and on one side repeats the radius of the FO, and lie closely thereon, and the other two sides of the wings are spherical, with an inward arc with varying radius, at both ends the wings are rounded and are tapering in the direction of rotation, so as to cut through the air mass easily, the height of the wings from the FO and width of the wing that lies on the body of the FO and the length of the wing, varies, and is calculated for each case separately.

6. Aerodynamic wing profile, characterized in that tail wings are fastened mechanically on the tail section of the body of the FO, they are made of flat metal of various known types, the tail wings are fastened on the body of the FO so that on one side they project at the back towards the discharge of exhaust gases, and at an angle to the axis of the FO, so that the exhaust gases on being discharged from the nozzle impinge on the wings tangentially and transmit a rotating force to the FO.

7. Wing according to claim 6, characterized in that the tail wings may be of heat-resistant metal in the form of flat bar stretched in the middle, and in the middle they are curved in different directions with varying angle of inclination.

8. Wing according to claim 6, characterized in that the tail wings transmit rotating force by any known method to the rim with the wings on the body of the FO.
